(19) United States
(12) Patent Application Publication
(10) Pub. No.: US 2009/0244147 A1
(43) Pub. Date: Oct. 1, 2009

(54) INK JET RECORDING APPARATUS

(75) Inventors: Kazuhiko Ohtsu, Mishima-shi (JP); Masashi Hiroki, Yokohama-shi (JP); Satoshi Kaiho, Yokohama-shi (JP); Takashi Kado, Izunokuni-shi (JP); Atsushi Kubota, Sunto-gun (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/410,729

(22) Filed: Mar. 25, 2009

Related U.S. Application Data
(60) Provisional application No. 61/040,896, filed on Mar. 31, 2008.

(51) Int. Cl. B41J 29/38; B41J 2/01

(52) U.S. Cl. 347/14; 347/102

(57) ABSTRACT

An ink jet recording apparatus includes an ink jet head in which nozzles ejecting aqueous pigment ink in accordance with gradation are arrayed, a sub scanning driving unit which carries a recording medium having an image formed thereon with the ink, a heating unit which selectively heats an area divided into an integral multiple of a minimum recording pixel in the recording medium, and a heating control unit which determines presence and absence of an image based on image information recorded to the recording medium, and controls the heating unit.

### CROSS-REFERENCE TO RELATED APPLICATION

This application claims the benefit of U.S. Provisional Application No. 61/040,896, filed on Mar. 31, 2008.

### TECHNICAL FIELD

The present invention relates to an ink jet recording apparatus that causes an ink jet head to eject aqueous ink and thus forms an image on a sheet.

### BACKGROUND

Conventionally, an ink jet recording apparatus using aqueous ink is popularly used in business offices and at home because the apparatus is capable of forming a high-quality image on normal paper, operates at low running costs, and is safe and quiet. Such an ink jet recording apparatus has advantages that a high-definition image can be recorded at a high speed, that less noise is generated because a non-impact system is employed, and that a color image can be easily recorded using multi-color ink.

In the ink jet recording apparatus, it is common to print on coated paper for ink jet having a highly ink-absorptive coating layer, matte paper, or the like. However, since coated paper for ink jet is expensive in terms of costs and also lacks writability, recently, it is more common that the ink jet recording apparatus prints on normal paper for PPC.

In such cases, if the ink jet recording apparatus prints on normal paper with aqueous ink jet ink, the ink spreads along fibers of normal paper because of the slow drying and infiltration of the ink. With normal paper, there are problems such as feathering and bleeding due to mixture of different colors, thus deteriorating image quality and so on.

Moreover, normal paper also has a problem of cockling and curling due to swelling of its paper fibers caused by moisture of ink.

To cope with these, the ink jet recording apparatus is provided with a heating dryer such as a warm-air fan or an electric heating element in order to dry a print part or a recording end part of a recording sheet in a forced manner if ink on the recorded recording sheet does not dry naturally or does not easily dry.

Here, an ink jet recording apparatus is already proposed in which a recording medium is heated from behind, before, during and after printing in order to acquire a more beautiful image when carrying out ink jet print on normal paper.

For example, JP-A-9-118008 discloses an ink jet recording method for recording while heating a recording medium. This method employs a configuration to control heating temperature of the recording medium in accordance with the infiltration speed of ink into the recording medium. With this ink jet recording method, no feathering or color mixture occurs on any recording medium, and no crack or the like occurs in the formed ink image. Thus, a color image that provides a recorded image with high contrast and excellent sharpness can be recorded.

Japanese Patent No. 2,761,671 discloses an ink jet recording apparatus which causes a recording unit to eject ink to a recording medium and thus carries out recording. This apparatus is configured to include a fixing unit which fixes ink on a recorded recording medium, a driving condition switching unit which changes a driving condition of the fixing unit, and a rear end part detecting unit which detects a rear end part of the recording medium. In the ink jet recording apparatus, timing when the rear end part of the recording medium passes the fixing unit is detected, and the driving condition of the fixing unit in this timing is switched by the driving condition switching unit so that the fixing effect is enhanced. This enables uniform drying over the entire recording medium.

Japanese Patent No. 3,327,796 discloses an ink jet recording apparatus using ink whose infiltration speed changes in accordance with the temperature of a recording medium. This apparatus is configured to include: a heating unit which heats the recording medium by regarding an area of a predetermined size as a unit; a receiving unit which receives designation information designating an area to be heated on the recording medium, together with image information; a storage unit which stores control information indicating a site to be heated and a site not to be heated on recording medium in accordance with the designation information; a control unit which controls the heating unit in accordance with the site to be heated and the site not to be heated on the recording medium, indicated by the control information; and a recording unit which scans, prints and records an image corresponding to the image information onto the recording medium while ejecting an ink drop. The ink jet recording apparatus and the recording method using this apparatus enables control of ink infiltration by partial and total heating control on the surface of the recording medium, and thus enables high-quality print output of a screen including different kinds of images such as a natural image and a character image.

JP-A-10-323974 discloses an ink jet recording apparatus which uses a recording head ejecting a recording liquid drop from an ejection port to attach the recording liquid drop to a recording target material, and thus forms an image. This apparatus is configured to include a carrying path through which the recording target material is carried, and a heating unit which is arranged in the carrying path and heats the recording target material and the recording liquid. The heating unit has a radiating heating element in which a radiation rate ε of infrared rays to be radiated has a peak waveform with its maximum value appearing in a wavelength range of 4 to 10 μm. The ink jet recording apparatus has the heating unit having high heating efficiency that enables sufficient improvement in image quality with small power consumption.

In any of the configurations disclosed in JP-A-9-118008, Japanese Patent No. 2,761,671, Japanese Patent No. 3,327,796, and JP-A-10-323974, feathering of ink and mixture with inks of other colors can be improved and improvement in image quality can be expected. However, if the peripheral part of an orifice of the ink jet recording head, particularly, the part immediately below the orifice of the ink jet head is heated, damage to the head orifice cannot be avoided. Particularly, in the case of on-demand print, there is an orifice of the ink jet recording head that is not driven and therefore does not eject ink. Thus, continuous heating of the peripheral part of this orifice may cause ejection failure and misdirection the next time the ink jet recording head ejects ink. Moreover, the user needs to frequently carry out maintenance of the ink jet recording head as preventive measures. This increases wasteful use of ink and unwanted waste of time taken for print operation for maintenance.

Also, in the ink jet recording apparatus, heat-drying is carried out irrespective of the area ratio of a print image to a recording sheet and its ink volume. This is often wasteful and also affects power consumption. Moreover, damage to a non-image part on the recording sheet surface due to heating cannot be avoided, either.

It is an object of the invention to provide an ink jet recording apparatus capable of efficiently heating a sheet on which an image is formed with ink.

### SUMMARY

According to an aspect of the invention, there is provided an ink jet recording apparatus including: an ink jet head in which nozzles ejecting aqueous pigment ink in accordance with gradation are arrayed; a sub scanning driving unit which carries a recording medium having an image formed thereon with the ink; a heating unit which selectively heats an area divided into an integral multiple of a minimum recording pixel in the recording medium; and a heating control unit which determines presence and absence of an image based on image information recorded to the recording medium, and controls the heating unit.

### DESCRIPTION OF THE DRAWINGS

FIG. 1 is a lateral sectional view of an ink jet recording apparatus according to a first embodiment.

FIG. 2 is a lateral sectional view of an ink jet recording apparatus according to a second embodiment.

FIG. 3 is a lateral sectional view of an ink jet recording apparatus according to a third embodiment.

FIG. 4 is a lateral sectional view of an ink jet recording apparatus according to a fourth embodiment.

FIG. 5 is a block diagram showing a control system of the ink jet recording apparatus according to the first to fourth embodiments.

FIG. 6 shows an arrangement of a heating resistor according to the first embodiment.

FIG. 7 shows an arrangement of a heating resistor according to the first embodiment.

FIG. 8 shows the relation between print resolution and heating cell resolution y according to the first embodiment.

FIG. 9 shows the relation between heating resistor pitch and nozzle pitch according to the first embodiment.

FIG. 10 shows the relation between heating resistor pitch and nozzle pitch according to the first embodiment.

FIG. 11 shows the relation between quantity of ink drop and quantity of heating according to the first embodiment.

FIG. 12 shows the relation between carrying speed and heating quantity according to the first embodiment.

### DETAILED DESCRIPTION

Hereinafter, embodiments of the invention will be described.

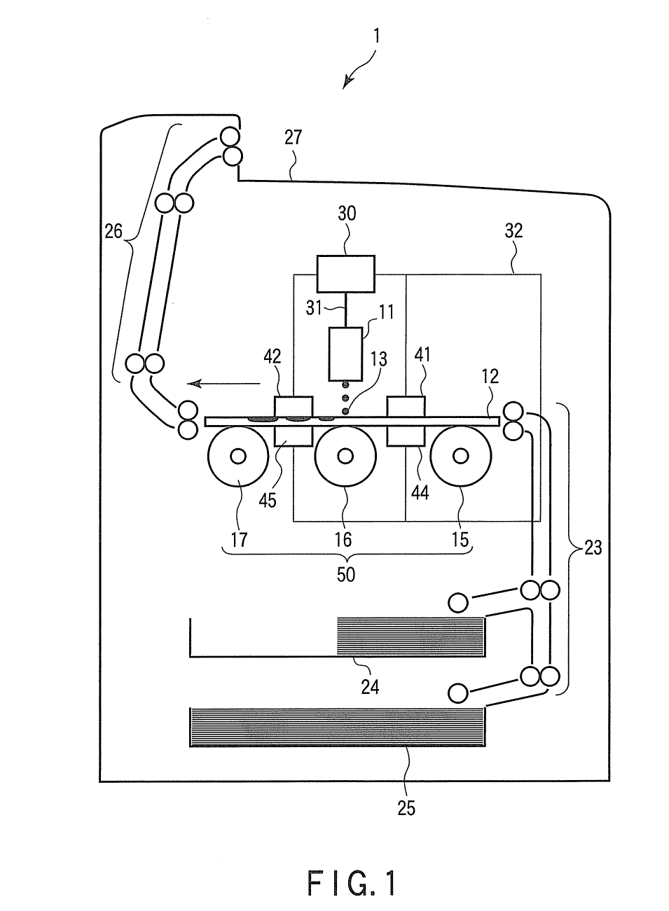

FIG. 1 is a lateral sectional view of an ink jet recording apparatus 1 according to a first embodiment. The ink jet recording apparatus 1 has an ink jet recording head 11, carrying rollers 15, 16 and 17 which carry a recording medium 12, a pre-print upper heating unit 41 and a pre-print lower heating unit 44, and a post-print upper heating unit 42 and a post-print lower heating unit 45. The ink jet recording head 11 ejects ink and forms a dot image on the recording medium 12. The carrying rollers 15, 16 and 17 carry the recording medium 12 in the direction of the arrow. That is, the carrying rollers 15, 16 and 17 are collectively referred to as a carrying unit 50 that relatively moves the recording medium 12 and the ink jet recording head 11.

A recording medium supply unit 23 that supplies the recording medium 12 to the carrying rollers 15, 16 and 17 is provided upstream of the carrying rollers 15, 16 and 17. The recording medium supply unit 23 carries the recording medium 12 stored in stockers 24 and 25. A recording medium discharge unit 26 which carries the recording medium 12 having an image pattern formed thereon to a paper discharge tray 27 provided on the top of the ink jet recording apparatus 1 is provided downstream of the carrying rollers 15, 16 and 17.

The pre-print upper heating unit 41 and the pre-print lower heating unit 44 are provided upstream of the ink jet recording head 11 in the carrying direction along the recording medium 12, facing each other to nip the face and back sides of the recording medium 12. The post-print upper heating unit 42 and the post-print lower heating unit 45 are provided downstream of the ink jet recording head 11 in the carrying direction along the recording medium 12, facing each other to nip the face and back sides of the recording medium 12.

Here, the recording medium 12 is basically normal paper. The ink ejected by the ink jet recording head 11 is aqueous pigment ink.

The ink jet recording apparatus 1 has a heating control unit 30 which controls the ink jet recording head 11, the pre-print upper heating unit 41, the pre-print lower heating unit 44, the post-print upper heating unit 42 and the post-print lower heating unit 45. The heating control unit 30 determines the presence or absence of an image based on image information recorded on the recording medium 12 and controls the pre-print upper heating unit 41, the pre-print lower heating unit 44, the post-print upper heating unit 42 and the post-print lower heating unit 45.

The heating control unit 30 receives an ejection signal of the ink jet recording head 11 selected in accordance with a print signal based on image information, via an ejection signal receiving path 31. The heating control unit 30 sends a heating control signal to the pre-print upper heating unit 41, the pre-print lower heating unit 44, the post-print upper heating unit 42 and the post-print lower heating unit 45 via a heating control signal transmission path 32 in accordance with the ejection signal of the ink jet recording head 11. The heating control unit 30 controls heating by the pre-print upper heating unit 41, the pre-print lower heating unit 44, the post-print upper heating unit 42 and the post-print lower heating unit 45 in a selective area. The pre-print upper heating unit 41, the pre-print lower heating unit 44, the post-print upper heating unit 42 and the post-print lower heating unit 45 efficiently heat a selected area of the recording medium 12 before and after ink strikes the recording medium 12.

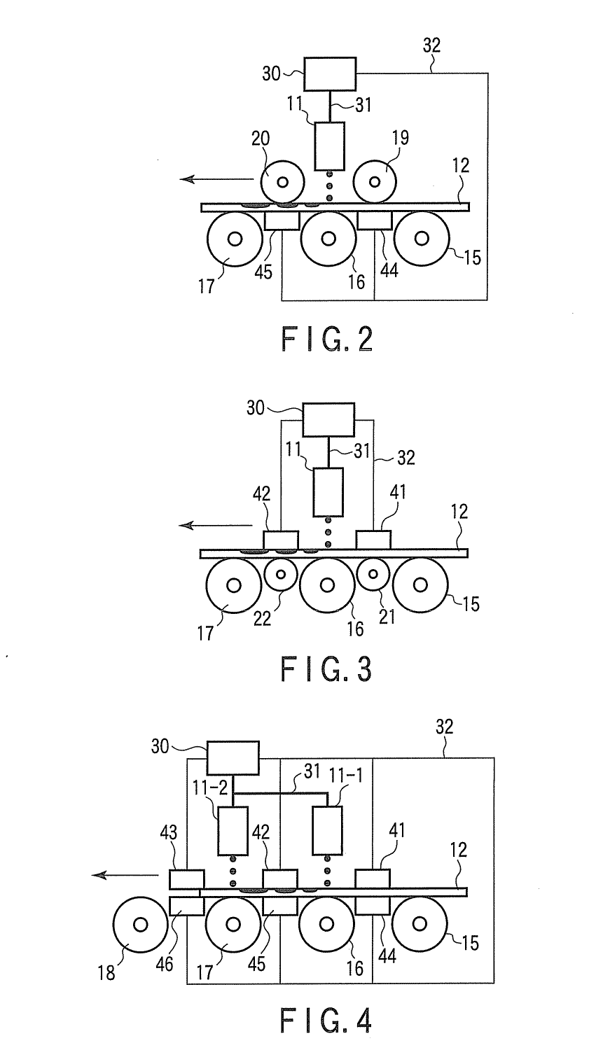

FIG. 2 is a lateral sectional view of an ink jet recording apparatus 1 according to a second embodiment. A pre-print pressurizing roller 19 and a post-print pressurizing roller 20 are arranged instead of the pre-print upper heating unit 41 and the post-print upper heating unit 42 according to the first embodiment shown in FIG. 1. The pre-print lower heating unit 44 is arranged on the back side of the recording medium 12, and the pre-print pressurizing roller 19 is arranged on the face side, facing the pre-print lower heating unit 44 so as to nip the recording medium 12. The post-print lower heating unit 45 is arranged on the back side of the recording medium 12, and the post-print pressurizing roller 20 is arranged on the face side, facing the post-print lower heating unit 45 so as to nip the recording medium 12. The pre-print lower heating unit 44 and the post-print lower heating unit 45 efficiently heat a selected area on the back side of the recording medium 12 before and after ink strikes the recording medium 12.

FIG. 3 is a lateral sectional view of an ink jet recording apparatus 1 according to a third embodiment. A pre-print pressurizing roller 21 and a post-print pressurizing roller 22 are arranged instead of the pre-print lower heating unit 44 and the post-print lower heating unit 45 according to the first embodiment shown in FIG. 1. The pre-print upper heating unit 41 is arranged on the face side of the recording medium 12, and the pre-print pressurizing roller 21 is arranged on the back side, facing the pre-print upper heating unit 41 so as to nip the recording medium 12. The post-print upper heating unit 42 is arranged on the face side of the recording medium 12, and the post-print pressurizing roller 22 is arranged on the back side, facing the post-print upper heating unit 42 so as to nip the recording medium 12. The pre-print upper heating unit 41 and the post-print upper heating unit 42 efficiently heat a selected area on the face side of the recording medium 12 before and after ink strikes the recording medium 12.

Also, as shown in FIG. 3, the pre-print upper heating unit 41 and the post-print upper heating unit 42 may be arranged on the face side of the recording medium 12, and the pressurizing rollers 21 and 22 may be arranged on the back side to nip the recording medium 12. Thus, a selected area on the surface of the recording medium 12 may be efficiently heated before and after ink strikes the recording medium 12.

FIG. 4 is a lateral sectional view of an ink jet recording apparatus 1 according to a fourth embodiment. In the fourth embodiment, plural ink jet recording heads 11 are arranged along the carrying direction of the recording medium 12. The ink jet recording heads 11 are arranged in order of the ink jet recording head 11-1 and the ink jet recording head 11-2 along the carrying direction of the recording medium 12.

The pre-print upper heating unit 41 and the pre-print lower heating unit 44 are provided at an upstream position from the ink jet recording head 11-1. The post-print upper heating unit 42 and the post-print lower heating unit 45 are provided at a position between the ink jet recording head 11-1 and the ink jet recording head 11-2. Moreover, a second post-print upper heating unit 43 and a second post-print lower heating unit 46 are provided at a downstream position from the ink jet recording head 11-2. The second post-print upper heating unit 43 is arranged on the face side of the recording medium 12, and the second post-print lower heating unit 46 is arranged on the back side, facing the second post-print upper heating unit 43 so as to nip the recording medium 12. A carrying roller 18 is provided downstream of the second post-print upper heating unit 43 and the second post-print lower heating unit 46.

The post-print upper heating unit 42 and the post-print lower heating unit 45 heat a selective area on the recording medium 12 after print, in accordance with a heating control signal based on an ejection signal of the ink jet recording head 11-1. The post-print upper heating unit 42 and the post-print lower heating unit 45 also heat a selective area on the recording medium 12 before print, in accordance with a heating control signal based on an ejection signal of the ink jet recording head 11-2. Therefore, the post-print upper heating unit 42 and the post-print lower heating unit 45 are controlled in a compound manner and efficiently heat a selected area on the recording medium 12.

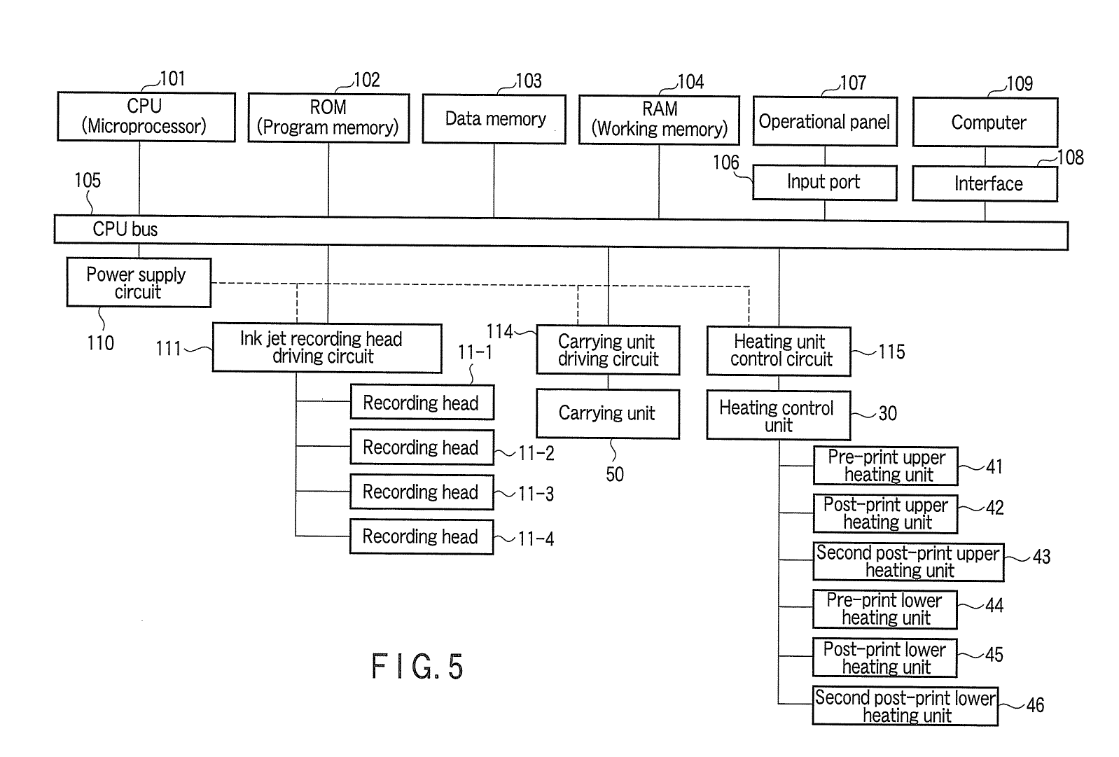

Now, a control system of the ink jet recording apparatus 1 according to the first to fourth embodiments will be described with reference to FIG. 5.

The control system of the ink jet recording apparatus 1 has a CPU (microprocessor) 101, a ROM (program memory) 102 and a RAM (working memory) 104 connected to the CPU 101 via a bus and constituting a microcomputer, a data memory 103 storing data, an operation panel 107 via an input port 106, and a interface 108 connecting an external computer 109. The operation panel 107 is provided to display setting details of the operating environment of the ink jet recording apparatus 1, or the operation state of an operation process. The operation panel 107 also receives feedback of an operation signal from the driving circuit of each unit and performs display or setting.

The CPU (microprocessor) 101 controls each of a power circuit 110, an ink jet recording head driving circuit 111, a carrying unit driving circuit 114, and a heating unit control circuit 115. The CPU 101 also performs drive control of each unit of the ink jet recording apparatus 1. The CPU 101 controls each unit in accordance with an operation program stored in the ROM 102 or the data memory 103.

The power circuit 110 supplies power to each unit. The ink jet recording head driving circuit 111 transfers a driving signal to the ink jet recording head 11-1, the ink jet recording head 11-2, the ink jet recording head 11-3 and the ink jet recording head 11-4 in accordance with the number of the ink jet recording heads configured as the ink jet recording heads 11. The ink jet recording head 11-1, the ink jet recording head 11-2, the ink jet recording head 11-3 and the ink jet recording head 11-4 eject ink by using an ink ejection control unit (not shown) on the basis of the driving signal, in accordance with timing of carrying the recording medium 12 by the carrying unit driving circuit 114. The carrying unit driving circuit 114 controls driving of the carrying roller 15, the carrying roller 16, the carrying roller 17 and the carrying roller 18, which constitute the carrying unit 50. The carrying unit 50 is configured to relatively move the recording medium 12 and the ink jet recording heads 11 by using the carrying unit driving circuit 114. The heating unit control circuit 115 transfers a driving signal to the heating control unit 30. The heating control unit 30 controls heating temperature, heating time, and on and off state of a heating area with respect to the pre-print upper heating unit 41, the pre-print lower heating unit 44, the post-print upper heating unit 42, the post-print lower heating unit 45, the second post-print upper heating unit 43 and the second post-print lower heating unit 46.

Next, the operation of the ink jet recording apparatus 1 according to the first embodiment will be described.

First, as the CPU 101 acquires print data or a command to be printed on the recording medium 12 transmitted from the computer 109 via the interface 108, the CPU 101 transfers the print data or command to the RAM 104. The CPU 101 performs image processing of the print data in accordance with the operation program stored in the ROM 102, command data stored in the data memory 103 and so on. Then, the CPU 101 performs drive controls of each unit of the ink jet recording apparatus 1 in an operation process according to an operation program, and performs control to record an image onto the recording medium 12.

The CPU 101 transmits the image-processed print data to the ink jet recording head driving circuit 111. The ink jet recording head driving circuit 111 transfers a driving signal to the ink jet recording head 11-1, the ink jet recording head 11-2, the ink jet recording head 11-3 and the ink jet recording head 11-4.

The ink jet recording head 11-1, the ink jet recording head 11-2, the ink jet recording head 11-3 and the ink jet recording head 11-4 selectively eject ink in the form of multi-drop ink drops from the nozzles in accordance with the driving signal on the recording medium 12. This processing is called main scanning driving. The carrying processing of the recording medium 12 by the carrying unit 50 is called sub scanning driving. Recording is executed by main scanning driving and sub scanning driving.

The CPU 101 simultaneously transmits a driving signal to the ink jet recording head driving circuit 111, the carrying unit driving circuit 114 and the heating unit control circuit 115. Each unit of the ink jet recording apparatus 1 is drive-controlled in the operation process according to the operation program. This enables recording of an image onto the recording medium 12. The power circuit 110 simultaneously outputs a driving voltage for the ink jet recording head 11-1, the ink jet recording head 11-2, the ink jet recording head 11-3 and the ink jet recording head 11-4, a motor driving voltage for driving the carrying unit 50, and an actuating voltage for the heating unit 30 as well.

Next, each unit involved in pixel pattern formation by the ink jet recording apparatus 1 according to this embodiment will be described. The ink jet recording head 11, which ejects ink and forms an ink pixel layer on the recording medium 12, is a line-type ink jet recording head. Nozzles are provided at a predetermined pitch on an end surface of the body of the ink jet recording head 11. The ink jet recording head 11 is also provided with an actuator at a position facing the nozzles via an ink chamber. The actuator includes a diaphragm and a piezoelectric vibrator attached to a top part of a partition that divides each ink chamber. When a voltage is applied to the piezoelectric vibrator in accordance with a driving signal formed according to a pixel pattern, the diaphragm is deformed and a pressure due to volume change in the ink chamber is propagated to the ink in the ink chamber. Then, the ink is ejected from the nozzles. The arraying pitch of the nozzles is properly selected in accordance with the density of pixels to be printed.

Here, for gradation print using an ink jet printer, an area gradation system may be employed in which plural dots form a matrix as one pixel without changing the size of ink drops as in the dither system, and the difference in the number of dots in the pixel expresses gradation. For gradation print, a density gradation system may also be employed in which the size of ink drops is made variable to change the density of one dot. Moreover, for gradation print, a multi-drop driving system may be employed in which the number of ink drops to be ejected per dot is made variable without changing the size of ink drops, thus realizing density gradation. Each of these systems has advantages and disadvantages. Therefore, a print system suitable for the purpose is used. In the first embodiment, the case of using a recording system based on the multi-drop driving system is described.

Next, the configuration of the pre-print upper heating unit 41 used in the first to fourth embodiments will be described. Although the configuration of the pre-print upper heating unit 41 is explained here, the post-print upper heating unit 42, the second post-print upper heating unit 43, the pre-print lower heating unit 44, the post-print lower heating unit 45 and the second post-print lower heating unit 46 have the similar configuration.

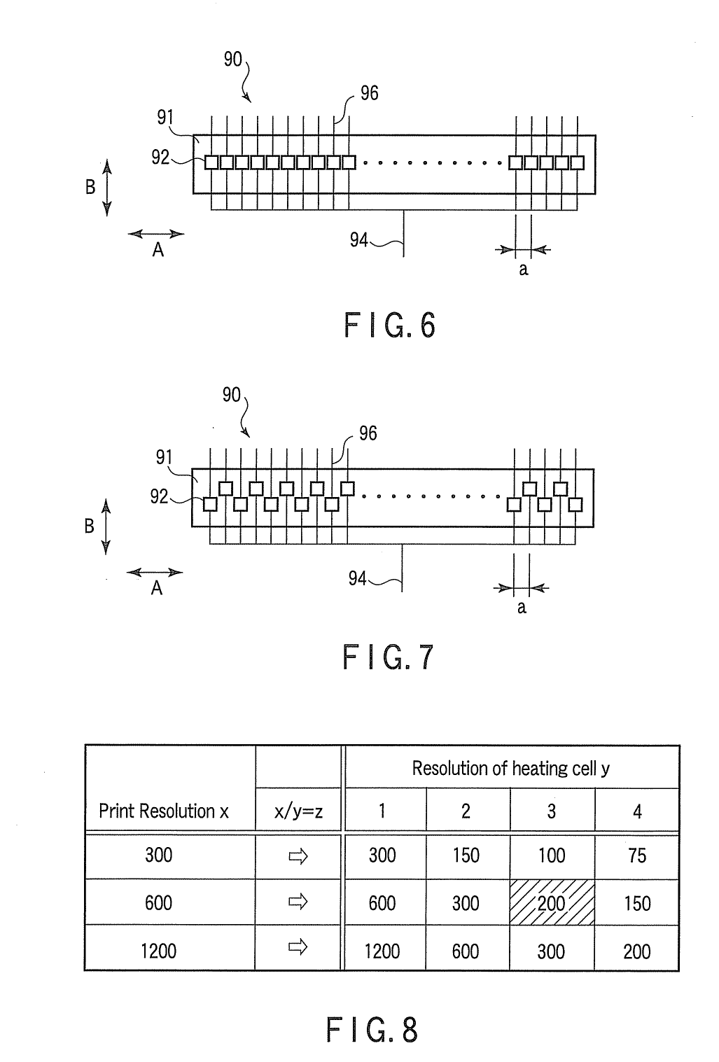

Plural heating resistors 92 are arranged in the pre-print upper heating unit 41, as shown in FIG. 6. A line-like heating resistor 90 includes the heating resistors 92 on an insulating substrate 91 at a pitch (heating resistor pitch a) that is at least an integral multiple of the nozzle pitch of the ink jet recording head 11, along the nozzle arraying direction (the scanning direction indicated by arrow A) of the ink jet recording head 11. The heating resistors 92 include at least a width size of an integral multiple of minimum pixels. Also in the direction of length (the sub scanning direction indicated by arrow B), the heating resistors 92 have a length size equivalent to the pitch (heating resistor pitch a) that is an integral multiple of the nozzle pitch, as in the nozzle arraying direction.

The heating resistors 92 are connected to a common electrode 94 and a signal electrode 96. The common electrode 94 connects all the heating resistors 92 arranged in the pre-print upper heating unit 41. The signal electrode 96 is connected every heating resistor 92. The surface of the heating resistors 92 is covered with a protection film. Each heating resistor 92 is driven by application of a predetermined driving voltage by the heating unit control circuit 115 via the connected signal electrode 96.

The line-like heating resistor 90 may be configured to have the heating resistors 92 in an alternate zigzag form with a shift equivalent to the heating resistor pitch a in the sub scanning direction, as shown in FIG. 7. In such a case, the heating unit control circuit 115 adjusts heating driving timing for each image in the sub scanning direction, with respect to each heating resistor 92.

As materials of the heating resistors 92, Ta—SiO₂-based materials, Zr—Al₂O₃-based materials, Cr—CrO—Si—SiO-based materials, ruthenium oxide, Ta₂N-based materials or the like are generally known. As materials of the common electrode 94 and the signal electrode 96, a combination of Cr, Pb and Au, a combination of Cr, Au and Cr, a combination of C and Al, a combination of Ti and Au, Au, a combination of Al and Mo, a combination of Al and Ni or the like are generally known.

Here, the pre-print upper heating unit 41 provided in the ink jet recording apparatus 1 controls the applied energy to each heating cell area at least in (z²×N)/n=M stages (with M being an integer), where print resolution is x dpi (x being an integer), divided resolution (heating cell resolution) is y dpi (y being an integer), x/y=z (z being an integer), and the number of drop gradation levels of the ink jet nozzle is N-value (N being an integer).

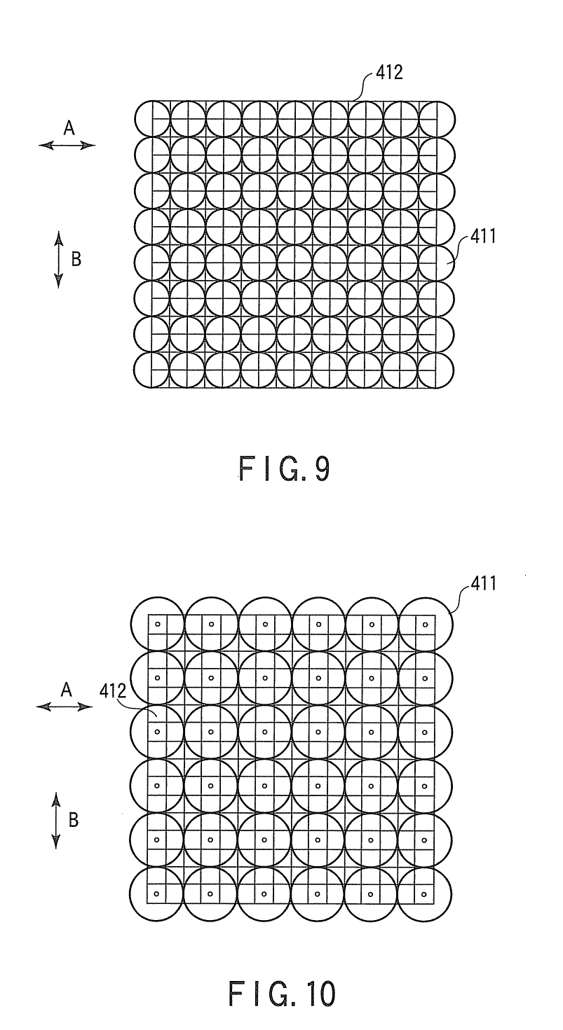

The pre-print upper heating unit 41 provided in the ink jet recording apparatus 1 is arranged in such a manner that the center of a heating cell area 411 is arranged at an adjoining part between minimum recording pixels 412 if z is an even number (as shown in FIG. 9), as will be described later. The pre-print upper heating unit 41 is arranged in such a manner that the center of the heating cell area 411 overlaps the center of the minimum recording pixel 412 if z is an odd number (as shown in FIG. 10).

FIG. 8 shows the relation between the print resolution x, which is 300 dpi, 600 dpi and 1200 dpi, and the heating cell resolution y of the pre-print upper heating unit 41, with the results 1, 2, 3 and 4 for x/y=z. Here, an exemplary case is described in which the print resolution x is 600 (dpi), the heating cell resolution y of the pre-print upper heating unit 41 is 200 (dpi), x/y=z is 3, the number of drop gradation levels of the ink jet nozzle is N=4 (value), and n=12 holds. In this case, the pre-print upper heating unit 41 performs control in (z²×N)/n=36/12=M=3 stages. Since n can be any integer, M may be 2, (3), 4, 6, 9, 12, 18 or 36 stages, depending on the value of n. The pre-print upper heating unit 41 achieves higher efficiency if the value of M is greater.

Next, the positional relation between a minimum pixel of an image on the recording medium 12 formed by ink ejected from the nozzles of the ink jet recording head 11 and an area heated by the line-like heating resistor 90. FIG. 9 shows a model where the heating resistors 92 are arrayed on the line along the main scanning direction of the ink jet recording head 11, at a pitch that is an even integral of the nozzle pitch of the ink jet recording head 11. Here, the case where the pitch of the heating resistors 92 is twice the nozzle pitch is explained. In this case, the pre-print upper heating unit 41 is arranged in such a manner that the center of the heating resistor 92 is located between pixels at intervals of two pitches.

FIG. 10 shows a case where the heating resistors 92 are arrayed on the line along the main scanning direction of the ink jet recording head 11, at a pitch that is an odd integral of the nozzle pitch of the ink jet recording head 11. Here, the case where the pitch of the heating resistors 92 is three times the nozzle pitch is explained. In this case, the pre-print upper heating unit 41 is arranged in such a manner that the center of the heating resistor 92 overlaps the center of each pixel at intervals of three pitches. As previously described, arrow A indicates the nozzle arraying direction (main scanning direction) and arrow B indicates the relative movement direction (sub scanning direction).

Here, the pre-print upper heating unit 41 corresponding to the positional relation shown in FIG. 10 will be described. Each of the heating resistors 92 arrayed in a line is driven by a driving signal (voltage) received via each signal electrode 96 from a control signal transmitted by the heating control unit 30. The heating control unit 30 properly selects a driving signal to be transmitted to each signal electrode 96, in accordance with information that is predetermined by the quantity of ink drops for each pixel pattern to be formed on the recording medium 12 corresponding to each heating resistor 92 and the carrying speed of the recording medium 12 and that is stored in the data memory 103. The heating timing based on the driving signal is determined by the carrying speed of the recording medium 12 and so on.

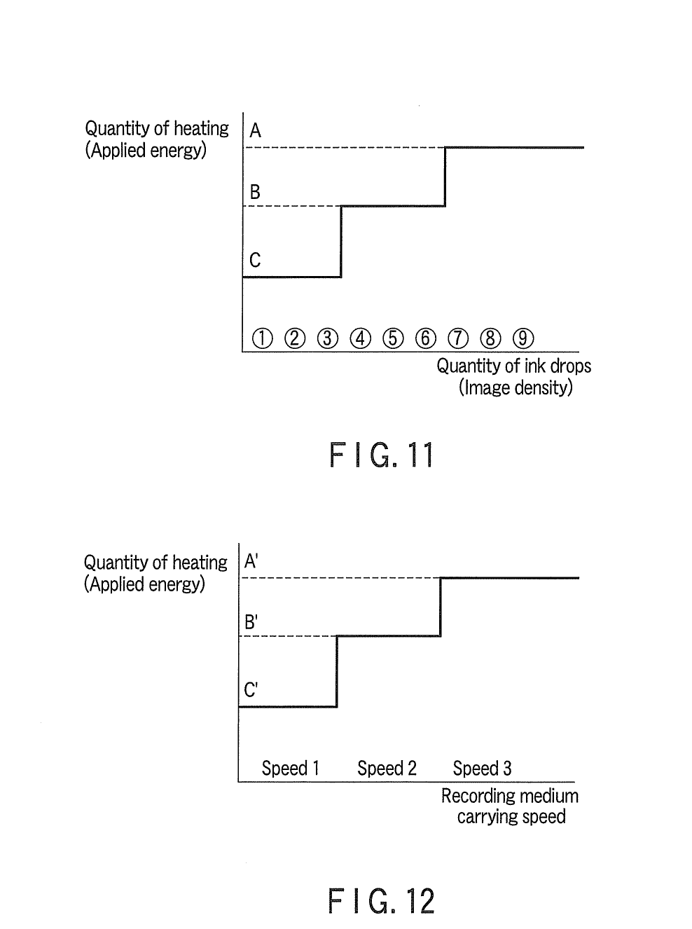

The ink jet recording apparatus 1 according to the first to fourth embodiments changes the quantity of heating by the pre-print upper heating unit 41 (applied energy or voltage) in accordance with the quantity of ink drops for each pixel pattern, as shown in FIG. 11. The ink jet recording apparatus 1 can also change the quantity of heating by the pre-print upper heating unit 41 in accordance with the carrying speed of the recording medium 12, as shown in FIG. 12. The CPU 101 properly decides specific quantities of heating (applied energy) in accordance with the characteristics of the ink jet recording apparatus 1. The data memory 103 stores information about such characteristics in advance.

Next, the operation of the ink jet recording apparatus 1 to change the quantity of heating by the pre-print upper heating unit 41 as shown in FIG. 11 or FIG. 12 and thus heat the recording medium 12 will be described.

First, as shown in FIG. 1, the recording medium supply unit 23 carries the recording medium 12 stored in the stockers 24 and 25, one by one to the carrying unit 50 of the ink jet recording apparatus 1. In the ink jet recording apparatus 1, the carrying rollers 15, 16 and 17 constituting the carrying unit 50 sequentially carry the recording medium 12 in the direction of the arrow.

The pre-print upper heating unit 41 and the pre-print lower heating unit 44 selectively carry out pre-print heating to the recording medium 12 carried by the carrying rollers 15, 16 and 17. The pre-print upper heating unit 41 and the pre-print lower heating unit 44 selectively heat a required area from both sides of the recording medium 12. Here, the first embodiment shown in FIG. 1 is explained. However, the same applies to the second embodiment shown in FIG. 2, the third embodiment shown in FIG. 3 and the fourth embodiment shown in FIG. 4. In the fourth embodiment, the post-print upper heating unit 42 and the post-print lower heating unit 45 serve to perform heat-drying of an image recorded by the ink jet recording head 11-1 and pre-print heating to enable recording by the ink jet recording head 11-2. Here, the post-print upper heating unit 42 and the post-print lower heating unit 45 need not perform pre-print heating, depending on the type of the recording medium 12, the type of ink and the ambient conditions including temperature and humidity.

The pre-print upper heating unit 41 performs selective pre-print heating to the recording medium 12 by using the heating resistors 92 in accordance with a control signal from the heating control unit 30. The heating control unit 30 decides a control signal to the pre-print upper heating unit 41 in accordance with a print signal based on image information transmitted to the ink jet recording head 11. The resolution of the pre-print upper heating unit 41 need not be aligned with image resolution in printing on the recording medium 12. It is very effective to make the resolution of the pre-print upper heating unit 41 lower than print resolution so that an area expanded to an integral multiple of a recording pixel 412 can be heated. For example, if the print resolution of the nozzle pitch of the ink jet recording head 11 is 600 dpi, it is effective to set the resolution of the arraying pitch of the heating resistors 92 arrayed in the pre-print upper heating unit 41 to 300 dpi, 200 dpi, 150 dpi and so on.

Here, the resolution of the arraying pitch of the heating resistors 92 arrayed in the pre-print upper heating unit 41 is 200 dpi, which is three times the pixel area with respect to the main scanning direction. As shown in FIG. 10, if the heating resistors 92 arrayed in the pre-print upper heating unit 41 selectively heat an area (heating cell area 411) divided into three times the minimum recording pixel 412 with respect to the main scanning direction, on the recording medium 12, one heating cell area 411 in the heating resistors 92 arrayed in the pre-print upper heating unit 41 is in charge of nine recording pixels 412.

The quantity of heating (applied energy or voltage) provided by one heating cell area 411 in the heating resistors 92 arrayed in the pre-print upper heating unit 41 is decided in accordance with the quantity of ink drops which are planned to be ejected by the ink jet recording head 11 according to image data with respect to the recording pixel 412. It is preferable that the pre-print upper heating unit 41 performs pre-print heating in such a manner that the surface temperature of the recording pixel 412 in the recording medium 12 becomes 40 to 70° C. when ink drops strike the recording medium 12.

Here, the configuration is described in which the heating resistors 92 arrayed in the pre-print upper heating unit 41 selectively heat an area having a size that is an integral multiple of the recording pixel 412 of the recording medium 12, in the main scanning direction and the sub scanning direction. However, it suffices that the pre-print upper heating unit 41 can selectively heat the above area, without being limited to this configuration.

In the recording area on the surface of the recording medium 12 heated by the pre-print upper heating unit 41 and the pre-print lower heating unit 44, an image is formed by ink drops ejected from the ink jet recording head 11 in accordance with image information. Then, the post-print upper heating unit 42 and the post-print lower heating unit 45 perform post-print heating, similar to the selective pre-print heating, to the recording medium 12 carried by the carrying rollers 15, 16 and 17 and having the image formed thereon. The heating control unit 30 decides a control signal to the post-print upper heating unit 42 and the post-print lower heating unit 45 in accordance with a print signal based on image information transmitted to the ink jet recording head 11. The post-print upper heating unit 42 and the post-print lower heating unit 45 selectively heat in accordance with the control signal from the heating control unit 30.

A case will be described in which the quantity of ink drops (image density) in the nine recording pixels 412 on the recording medium 12 covered by one heating cell area 411 of the pre-print upper heating unit 41 as shown in FIG. 10 is distributed in nine stages in order from (1) to (9). The one heating cell area 411 of the pre-print upper heating unit 41 provides a quantity of heating C for the quantity of ink drops (1), (2) or (3), a quantity of heating B for (4), (5) or (6), and a quantity of heating A for (7), (8) or (9), as shown in FIG. 11. As described above, since the pre-print upper heating unit 41 controls heating in M=3 stages, the quantity of heating is divided into three stages, that is, the quantities of heating A, B and C. Therefore, the pre-print upper heating unit 41 changes the number of stages for the quantity of heating in accordance with the value of M. To dry ink, it is preferable that the pre-print upper heating unit 41 controls the surface temperature of the recording pixels 412 in the recording medium 12 to 30 to 90° C., and particularly to 40 to 70° C.

The relation between the quantity of ink drops and the quantity of heating will be described further in detail. In the first embodiment, the number of drop gradation levels of the ink jet nozzle is set at N=4 (value), as described above. Therefore, since each of the nine recording pixels 412 has four gradation levels, the quantity of ink drops covered by one heating cell area 411 in the pre-print upper heating unit 41 is 36, that is, equivalent to 36 drops. Thus, if the quantity of ink drops is equally divided into nine stages, the quantity of ink drops (1) is 1 to 4 drops, (2) is 5 to 8 drops, (3) is 9 to 12 drops, (4) is 13 to 16 drops, (5) is 17 to 20 drops, (6) is 21 to 24 drops, (7) is 25 to 28 drops, (8) is 29 to 32 drops, and (9) is 33 to 36 drops. The pre-print upper heating unit 41 sets the corresponding heating cell area 411, using the quantity of heating C necessary for drying with respect to the quantities of ink drops (1) to (3), the quantity of heating B necessary for drying with respect to the quantities of ink drops (4) to (6), and the quantity of heating A necessary for drying with respect to the quantities of ink drops (7) to (9).

The pre-print upper heating unit 41 controls the quantity of heating in one heating cell area 411 in accordance with speed 1, speed 2 and speed 3 (here, three stages are used because M=3) as the carrying speed of the recording medium 12 by the carrying rollers 15, 16 and 17, as shown in FIG. 12. In this case, as in the case of controlling the quantity of heating in accordance with the quantity of ink drops, the pre-print upper heating unit 41 can efficiently dry ink drops on the recording medium 12. Specifically, the pre-print upper heating unit 41 provides a quantity of heating C′ to a selected pixel area on the recording medium 12 by using the heating resistors 92 in the line, if the carrying speed of the recording medium 12 is within the range of speed 1. The pre-print heating unit 41 provides a quantity of heating B′ if the carrying speed is within the range of speed 2. The pre-print heating unit 41 provides a quantity of heating A′ if the carrying speed is within the range of speed 3.

After the post-print upper heating unit 42 and the post-print lower heating unit 45 heat the recording medium 12 in accordance with the above control, the recording medium discharge unit 26 carries the recording medium 12 to the paper discharge tray 27. The recording medium 12, which is housed in the paper discharge tray 27, has an image pattern formed thereon and is heated and dried, becomes a printed matter with high print quality with feathering and bleeding of ink jet recording restrained and with little cockling and curling.

With the ink jet recording apparatus 1, the control to change the quantity of heating (applied energy or voltage) applied to the pre-print upper heating unit 41, the pre-print lower heating unit 44, the post-print upper heating unit 42, the post-print lower heating unit 45, the second post-print upper heating unit 43 and the second post-print lower heating unit 46 in accordance with the quantity of ink drops per unit pixel or the carrying speed of the recording medium 12 is described. Other than this, the quantity of heating (applied energy) may also be changed in accordance with the thickness of the recording medium 12, the type of the recording medium 12, and the type of ink.

As described above, the ink jet recording apparatus 1 can selectively change the quantity of heating in accordance with the image pattern of an image recorded on the recording medium, the carrying speed and the type of recording medium, and therefore can efficiently heat an image part and a non-image part on the recording medium. Therefore, the ink jet recording apparatus 1 can restrain the quantity of energy required for heating, leading to restraining of power consumption based on energy saving. Moreover, since the ink jet recording apparatus 1 basically does not heat a non-image part, damage due to heating to the surface of a recording sheet in the non-image part can be avoided. That is, the ink jet recording apparatus 1 can control feathering and bleeding of an image on the recording medium, restrain cockling and curling proper to aqueous ink, and provide a recorded image with high print quality.

Also, the ink jet recording apparatus 1 selectively heats the area (the heating cell area 411) divided into a integral multiple of the minimum recording pixel 412 of the recording medium. Therefore, heating resistor density of a heater with low resolution can be selected and this is advantageous in terms of costs.

Meanwhile, when the heated recording medium continuously passes directly below the ink jet recording head 11, the ink in the nozzles of the ink jet recording head 11 is heated and thus the solvent is gradually dried. This causes condensation of pigment due to increased pigment density in the ink and thus increases the occurrence of ejection failure. The ink jet recording apparatus 1 according to the embodiments selectively heats a part on the recording medium to which ink is to be adhered or ink is already adhered. Thus, in the ink jet recording apparatus 1, the vicinity of a nozzle in the ink jet recording head 11 which does not eject ink to the recording medium is not heated. Therefore, ejection failure of the nozzles of the ink jet recording head 11 and damage due to temperature rise in the vicinity of the nozzles can be restrained as much as possible.

What is claimed is:

1. An ink jet recording apparatus comprising:
an ink jet head in which nozzles ejecting aqueous pigment ink in accordance with gradation are arrayed;
a sub scanning driving unit which carries a recording medium having an image formed thereon with the ink;
a heating unit which selectively heats an area divided into an integral multiple of a minimum recording pixel in the recording medium; and
a heating control unit which determines presence and absence of an image based on image information recorded to the recording medium, and controls the heating unit.

2. The apparatus of claim 1, wherein the heating unit is provided at a position where an image is formed by the ink jet head, or upstream or downstream of the position, along a direction in which the recording medium is moved relatively with respect to the ink jet head by the sub scanning driving unit.

3. The apparatus of claim 2, wherein the ink jet head ejects the ink to the recording medium by using a multi-drop system.

4. The apparatus of claim 2, wherein the heating units are provided to face each other via the recording medium provided between them.

5. The apparatus of claim 2, wherein the heating unit heats the recording medium from a side opposite to an image forming surface of the recording medium.

6. The apparatus of claim 5, comprising a pressurizing unit at a position which is on the image forming surface of the recording medium and facing the heating unit.

7. The apparatus of claim 2, wherein the heating unit has a heating cell along an arraying direction of the nozzles.

8. The apparatus of claim 7, wherein the heating cell changes a quantity of heating stepwise in accordance with a quantity of drops of the ink.

9. The apparatus of claim 7, comprising a control unit which controls applied energy of the heating cell at least in (z²×N)/n=M stages (with M being an integer), where print resolution is x dpi (x being an integer), divided resolution of the heating unit is y dpi (y being an integer), x/y=z (z being an integer), and the number of drop gradation levels of the nozzles of the ink jet head is N(N being an integer).

10. The apparatus of claim 9, wherein the control unit changes a heating temperature of the heating cell in accordance with a carrying speed of the recording medium.

11. The apparatus of claim 9, wherein the control unit changes a heating temperature of the heating cell in accordance with type of the recording medium.

12. The apparatus of claim 9, wherein the heating unit is arranged in such a manner that the center of the heating cell is located at an adjoining part between minimum recording pixels with respect to a direction orthogonal to a carrying direction of the recording medium if the z is an even number, and the center of the heating cell overlaps the center of the minimum recording pixel with respect to the direction orthogonal to the carrying direction of the recording medium if the z is an odd number.

13. An ink drying method comprising:
carrying a recording medium on which an image is formed by ejecting aqueous pigment ink from nozzles of an ink jet head in accordance with gradation;
determining presence or absence of an image based on image information recorded to the recording medium; and
selectively heating an area divided into a integral multiple of a minimum recording pixel in the recording medium.

14. The method of claim 13, comprising ejecting the ink to the recording medium by using a multi-drop system.

15. The method of claim 14, comprising changing a quantity of heating stepwise in accordance with a quantity of drops of the ink.

16. The method of claim 14, comprising controlling applied energy of a heating cell at least in (z²×N)/n=M stages (with M being an integer), where print resolution is x dpi (x being an integer), divided resolution of a heating unit is y dpi (y being an integer), x/y=z (z being an integer), and the number of drop gradation levels of the nozzles of the ink jet head is N(N being an integer).

17. The method of claim 16, comprising changing a heating temperature of the heating cell in accordance with a carrying speed of the recording medium.

18. The method of claim 16, comprising changing a heating temperature of the heating cell in accordance with type of the recording medium.

19. The method of claim 16, comprising heating in such a manner that the center of the heating cell is located at an adjoining part between minimum recording pixels with respect to a direction orthogonal to a carrying direction of the recording medium if the z is an even number, and the center of the heating cell overlaps the center of the minimum recording pixel with respect to the direction orthogonal to the carrying direction of the recording medium if the z is an odd number.

20. An ink jet recording apparatus comprising:
means for ejecting aqueous pigment ink in accordance with gradation, from an ink jet head having nozzles arrayed therein;
means for carrying a recording medium having an image formed thereon with the ink;
means for selectively heating an area divided into an integral multiple of a minimum recording pixel in the recording medium; and
means for determining presence and absence of an image based on image information recorded to the recording medium, and controlling the selective heating.
